(19) United States
(12) Patent Application Publication
(10) Pub. No.: US 2022/0405640 A1
(43) Pub. Date: Dec. 22, 2022

(54) LEARNING APPARATUS, CLASSIFICATION APPARATUS, LEARNING METHOD, CLASSIFICATION METHOD AND PROGRAM

(71) Applicant: NIPPON TELEGRAPH AND TELEPHONE CORPORATION, Tokyo (JP)

(72) Inventors: Yoichi CHIKAHARA, Tokyo (JP); Akinori FUJINO, Tokyo (JP)

(73) Assignee: NIPPON TELEGRAPH AND TELEPHONE CORPORATION, Tokyo (JP)

(21) Appl. No.: 17/772,098

(22) PCT Filed: Oct. 29, 2019
(86) PCT No.: PCT/JP2019/042339

§ 371 Date: Apr. 26, 2022

(51) Int. Cl. G06N 20/00

(52) U.S. Cl. CPC G06N 20/00

(57) ABSTRACT

A learning apparatus according to an embodiment includes: input means for inputting training data for learning a classifier and a causal graph representing causal relationships between variables included in the training data; and learning means for learning the classifier by solving a constrained optimization problem in which a mean of causal effects between predetermined variables is within a predetermined range and a variance of the causal effects is equal to or smaller than a predetermined value, using the training data and the causal graph input by the input means.

### TECHNICAL FIELD

The present invention relates to a learning apparatus, a classification apparatus, a learning method, a classification method and a program.

### BACKGROUND ART

When there is a relationship of a cause and an effect (i.e., a causal relationship) between two variables, causal effect is a known measure for quantifying influence that the variable as the cause has on the variable as the effect. There also are known techniques for learning a classifier while removing causal effect between particular variables using the causal relationship between those variables as prior knowledge. In recent years, attention has been paid to employing a classifier in handling of decision making problems related to individuals, such as recruiting at a company or release of a prisoner at a trial, as an application of such techniques.

For such an application, it is required that non-discriminatory decision making (i.e., a fair decision making) be made in terms of features of an individual, such as race, sex, and sexual orientation (hereinafter referred to as “sensitive features”). Doing decision making in consideration of such fairness is very important in learning of a classifier. This is because discriminatory bias related to sensitive features, such as correlation between a sensitive feature and a decision result, is often included in training data since training data used for learning a classifier is the results of decision makings that were actually made by people in the past.

Thus, more recently, techniques for learning a classifier while removing causal effects between a sensitive feature and decision results have been proposed for fairness-conscious classification problems. For example, Non-Patent Literature 1 proposes a technique for learning a classifier by solving an optimization problem with imposition of a constraint such that the mean value of causal effects will be zero when causal effects between a sensitive feature and decision results are estimated for a group of individuals.

### CITATION LIST

### Non-Patent Literature

Non-Patent Literature 1: Razieh Nabi, Ilya Shpitser, “Fair Inference on Outcomes”, Proceedings of the 32nd AAAI Conference on Articial Intelligence, p. 1931-1940, 2018.

### SUMMARY OF THE INVENTION

### Technical Problem

However, with the technique proposed in Non-Patent Literature 1, for example, causal effects might be large values for some individuals although the mean value of causal effects is zero for the entire group. Consequently, some individuals can receive a decision result that is largely affected by a sensitive feature (i.e., a non-fair, discriminatory decision result).

In view of the foregoing, an object of an embodiment of the present invention is to learn a classifier while removing causal effects in each training data.

### Means for Solving the Problem

To attain the object, a learning apparatus according to an embodiment of the present invention includes: input means for inputting training data for learning a classifier and a causal graph representing causal relationships between variables included in the training data; and learning means for learning the classifier by solving a constrained optimization problem in which a mean of causal effects between predetermined variables is within a predetermined range and a variance of the causal effects is equal to or smaller than a predetermined value, using the training data and the causal graph input by the input means.

### Effects of the Invention

It is possible to learn a classifier while removing causal effects in each training data.

### BRIEF DESCRIPTION OF DRAWINGS

FIG. 1 shows an example of a causal graph representing causal relationships between variables.

FIG. 2 shows an example of functional configurations of a learning apparatus and a classification apparatus according to an embodiment of the present invention.

FIG. 3 is a flowchart showing an example of a learning process according to the embodiment.

FIG. 4 is a flowchart showing an example of a classification process according to the embodiment.

FIG. 5 shows an example of hardware configurations of the learning apparatus and the classification apparatus according to the embodiment.

### DESCRIPTION OF EMBODIMENTS

An embodiment of the present invention is now described. In the present embodiment, a learning apparatus 10 that can learn a classifier while removing causal effects in each training data and a classification apparatus 20 that classifies data with the classifier learned by the learning apparatus 10 are described.

The embodiment described below considers (1) a constrained optimization problem that imposes not only the mean value of causal effects but a variance value thereof as constraints, and in particular (2) a case where a classifier is represented as a non-convex function such as a neural network. In such a case, the variance of causal effects will be a non-convex and non-smooth function and the problem to be solved will be a non-convex and non-smooth optimization problem, so that it is generally difficult to create an optimization algorithm with convergence guarantee. Accordingly, in the present embodiment, (3) an objective function is formulated as a weakly convex function, thereby enabling application of an existing optimization algorithm with convergence guarantee. These (1) to (3) allow the learning apparatus 10 according to the present embodiment to learn a classifier while removing causal effects in each training data. It in turn enables the classification apparatus 20 according to the present embodiment to perform classification without being affected by sensitive features in classification target data using a classifier learned by the learning apparatus 10.

<Theoretical Configuration>

Next, a theoretical configuration of the present embodiment is described. The present embodiment considers a classification problem for learning a probabilistic classifier that takes a variable X formed from multiple variables as input and predicts a variable Y, while removing the causal effect of a variable A ∈ X on the variable Y. As training data used for learning the classifier, observations {(x₁, y₁), . . . , (xₙ, yₙ)} are used. Here, xᵢ(i=1, . . . , n) is an observed value of the variable X, and yᵢ(i=1, . . . , n) is an observed value of the variable Y when xᵢ is observed.

For example, with a problem of decision making related to individuals, the variable X can represent a feature of each individual, the variable Y can represent the decision result of decision making for each individual, and the variable A can represent a sensitive feature (e.g., race, sex, sexual orientation, etc.). The training data is data that records the features of each individual and the decision result of decision making that was actually made for that individual by a person in past. For the following description, a decision making problem related to individuals is assumed, where the variable X is a feature of each individual, the variable Y is the decision result of decision making for each individual, and the variable A is a sensitive feature.

Let h_{θ} be a probabilistic classifier that should be learned (hereinafter also referred to just as “classifier”) and let θ a parameter thereof. An error function for quantifying an accuracy of the classifier h_{θ} is denoted as 1, and a function representing a causal effect for quantifying the fairness of the classifier h_{θ} for an individual having the feature X is denoted as g_{θ} (x).

In the present embodiment, the constrained optimization problem shown in Expression (1) below is solved in order to acquire a parameter θ that minimizes a prediction error with the error function l and makes the causal effect on each individual zero:

$$\begin{matrix}[ Math . 1 ] & \\ \begin{matrix}{minimize}_{θ} & {E}_{{\hat{P}}_{n}} [ l ( {h}_{θ} ( X ) , Y ) ] \\ subject to & - δ \leq {E}_{{\hat{P}}_{n}} [ {g}_{θ} ( X ) ] \leq δ , {Var}_{{\hat{P}}_{n}} [ g θ ( X ) 1 \leq ζ\end{matrix} & ( 1 )\end{matrix}$$

Here,

\hat{P}ₙ [Math. 2]

is an empirical distribution of the training data {(x₁, y₁), . . . , (xₙ, yₙ)}, with constraints being imposed so that the mean of causal effects:

E_{\hat{P}}_{ₙ}[g_{θ}(X)] [Math. 3]

is within a range of equal to or greater than −δ and equal to or smaller than δ and that the variance of causal effects:

Var_{\hat{P}}_{ₙ}[g_{θ}(X)] [Math. 4]

is equal to or smaller than ζ. δ≥0 and ζ≥0 are hyperparameters.

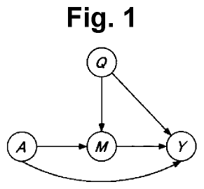

The function g_{θ} representing a causal effect is represented as a function of θ based on the estimate described in Reference Literature 1: Huber, Martin and Solovyeva, Anna, “Direct and indirect effects under sample selection and outcome attrition,” Working Paper, Universite de Fribourg, 2018. The function representing a causal effect is represented in different forms depending on causal relationships between variables and the causal effect between which variables is to be considered. For example, in a case where variables {X, Y}={A, M, Q, Y} and the causal relationships between these variables A, M, Q and Y are represented by a causal graph as shown in FIG. 1, when focusing on the causal relationship between the variables A and Y, the function representing the causal effect is represented by Expression (2):

$$\begin{matrix}[ Math . 5 ] & \\ {g}_{θ} ( x ) = w \{ {h}_{θ} ( 1 , m , q ) - {h}_{θ} ( 0 , m , q ) \} where w = \frac{P ( A = 0 \vert m , q )}{P ( A = 0 \vert q )} & ( 2 )\end{matrix}$$

Here, w>0 represents a weight parameter, determined by the values of conditional probabilities P(A=0|m, q) and P(A=0|q). These conditional probability values can be estimated by previously learning a model such as logistic regression and neural network using training data. For the foregoing, it is assumed that the variable A can take either 0 or 1, and m and q represent observed values of the variables M and Q, respectively.

Rather than directly solving the constrained optimization problem shown in Expression (1) above using a function value (estimate) g_{θ} estimated with Expression (2) above, the present embodiment considers an objective function that approximates the constrained optimization problem shown in Expression (1) above. This is because if the constrained optimization problem shown in Expression (1) above is to be directly solved based on the estimate g_{θ} shown in Expression (2) above and when classifier h_{θ} is a non-convex function, the optimization problem will be a non-convex and non-smooth optimization problem and it will be difficult to create an optimization algorithm with convergence guarantee in general. A function being non-smooth means that a derivative of the function is not Lipschitz continuous.

Accordingly, for a problem that imposes a constraint on each of the mean and variance of causal effects (the constrained optimization problem shown in Expression (1) above), the present embodiment considers solving the constrained optimization problem shown in Expression (1) above in an approximating manner by optimizing an objective function that uses a penalty function for constraining a sum of the mean and the variance with respect to absolute values of causal effects. Specifically, consider the sum of the mean and a standard deviation of causal effects:

E_{\hat{P}}_{ₙ}[|g_{θ}(X)|]+{square root over (Var_{\hat{P}}_{ₙ}[|g_{θ}(X)|])} [Math. 6]

This is an amount called an upper confidence bound in the context of statistics.

The present embodiment designs the penalty function using the approximate estimate for the upper confidence bound described in Reference Literature 2: Namkoong, Hongseok and Duchi, John C., “Variance-based regularization with convex objectives” NeurIPS, pages 2971-2980, 2017. Using the approximate estimate described in Reference Literature 2, the upper confidence bound for the absolute values of causal effects can be approximated with Expression (3) below:

$$\begin{matrix}[ Math . 7 ] & \\ {E}_{{\hat{P}}_{n}} [ \vert {g}_{θ} ( X ) \vert ] + \sqrt{\frac{2 ρ}{n} {Var}_{{\hat{P}}_{n}} [ \vert {g}_{θ} ( X ) \vert ]} = {max}_{p ∈ {𝒫}_{ρ , n}} {E}_{p} [ \vert {g}_{θ} ( X ) \vert ] & ( 3 )\end{matrix}$$

Here,

[symbol]

_{ρ,n} [Math. 8]

represents a set of distributions analogous to an empirical distribution:

\hat{P}ₙ [Math. 9]

and is represented by Expression (4) below:

$$\begin{matrix}[ Math . 10 ] & \\ {𝒫}_{ρ , n} = \{ p ∈ {ℝ}^{n} : {\sum }_{i = 1}^{n} {p}_{i} = 1 ( {p}_{i} \geq 0 ) , V ( p \vert \vert {\hat{P}}_{n} ) \leq ρ \} & ( 4 )\end{matrix}$$

Here,

V(p∥\hat{P}ₙ)=½Σᵢ₌₁ⁿ(npᵢ−1)² [Math. 11]

is a measure of similarity between distributions called X²-divergence (chi square divergence), quantifying the similarity between two distributions:

p,\hat{P}ₙ [Math. 12]

This is controlled by a hyperparameter ρ>0.

In the present embodiment, the objective function shown in Expression (5) below is optimized using the approximate estimate shown in Expression (3) above.

$$\begin{matrix}[ Math . 13 ] & \\ {min}_{θ} {max}_{p ∈ {𝒫}_{ρ , n}} {E}_{{\hat{P}}_{n}} [ l ( {h}_{θ} ( X ) , Y ) ] + ν {E}_{p} [ \vert {g}_{θ} ( X ) \vert ] = {min}_{θ} {max}_{p ∈ {𝒫}_{ρ , n}} \frac{1}{n} {\sum }_{i = 1}^{n} l ( {h}_{θ} ( {x}_{i} ) , {y}_{i} ) + ν {\sum }_{i = 1}^{n} {p}_{i} \vert {g}_{θ} ( {x}_{i} ) \vert & ( 5 )\end{matrix}$$

The objective function shown in Expression (5) above can be rewritten into the objective function shown in Expression (6) below, which has no constraint on distribution p:

$$\begin{matrix}[ Math . 14 ] & \\ {min}_{θ} {max}_{p} \frac{1}{n} {\sum }_{i = 1}^{n} l ( {h}_{θ} ( {x}_{i} ) , {y}_{i} ) + ν {\sum }_{i = 1}^{n} {p}_{i} \vert {g}_{θ} ( {x}_{i} ) \vert - \frac{λ}{2} {\sum }_{i = 1}^{n} {( {np}_{i} - 1 )}^{2} & ( 6 )\end{matrix}$$

Here, the second term of Expression (6) above is a penalty function that constrains the mean and variance of the absolute values of causal effects and the degree of its penalty is controlled by a hyperparameter ν>0. The third term of Expression (6) above is the chi square divergence between two distributions:

p,\hat{P}ₙ, [Math. 12]

controlled by a hyperparameter λ>0.

The objective function shown in Expression (6) above belongs to a function class called weakly convex function when the error function l is represented by a Lipschitz continuous convex function (e.g., cross-entropy loss and the like) and the classifier h_{θ} is represented by a non-convex and smooth function (e.g., a type of neural network for which an activation function is represented by a smooth function such as a sigmoid function). A weakly convex function means a function having properties similar to those of a convex function.

Several optimization algorithms have recently been proposed for optimization problems where the objective function is represented in the form of a weakly convex function. Thus, the present embodiment performs learning of the classifier h_{θ} such that there is convergence guarantee by optimizing the objective function shown in Expression (6) above using the optimization algorithm called PG-SMD described in Reference Literature 3: Rafique, Hassan and Liu, Mingrui and Lin, Qihang and Yang, Tianbao. “Non-convex min-max optimization: Provable algorithms and applications in machine learning” arXiv, 2018.

As described above, the present embodiment learns the classifier h_{θ} by optimizing an objective function that approximates the constrained optimization problem shown in Expression (1) above (the objective function shown in Expression (6) above) with PG-SMD. This enables the classifier h_{θ} to be learned such that there is convergence guarantee while removing causal effect on each individual even when a classifier h_{θ} represented by a non-convex function, e.g., a neural network, is used.

<Functional Configuration>

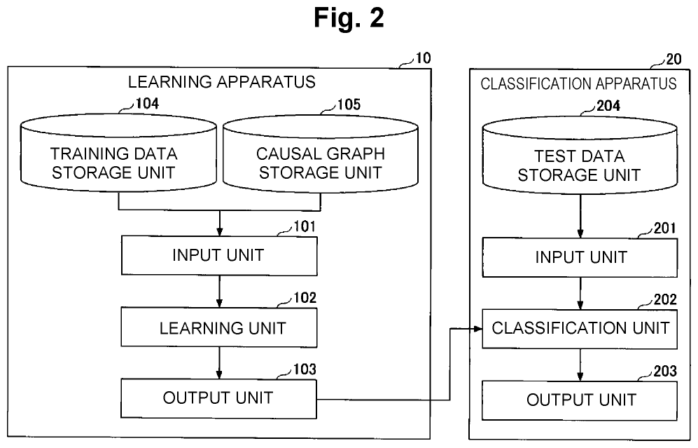

Now referring to FIG. 2, functional configurations of the learning apparatus 10 and the classification apparatus 20 according to the present embodiment are described. FIG. 2 shows an example of the functional configurations of the learning apparatus 10 and the classification apparatus 20 according to the present embodiment.

As shown in FIG. 2, the learning apparatus 10 in the present embodiment includes an input unit 101, a learning unit 102, an output unit 103, a training data storage unit 104 and a causal graph storage unit 105.

The training data storage unit 104 has stored therein training data for learning the classifier h_{θ}. The causal graph storage unit 105 has stored therein a causal graph representing causal relationships between variables.

When a learned classifier h_{θ} is used in recruiting related to an occupation that requires physical strength such as a construction job, for example, a specific example of training data is data that records features of past applicants and results of recruitment (accepted or rejected) for those applicants. A specific example of a corresponding causal graph is a graph representing causal relationships between variables representing the features of each applicant and the result of recruitment, such as variable A representing the sex of each applicant, variable Q representing a qualification, variable M representing a physical test score, and variable Y representing the result of recruitment. For this specific example, the causal graph can be the graph shown in FIG. 1, for example.

In the case of the specific example above, it is discriminatory to determine the result of recruitment (variable Y) based on sex (variable A), but it is not necessarily discriminatory to determine the result of recruitment (variable Y) using the result of a physical test (variable M) because a construction job is an occupation requiring physical strength or to determine the result of recruitment (variable Y) considering a qualification (Q), such as a qualification to operate a construction machine. Thus, for this specific example, the variable A is defined as a sensitive feature and attention is focused on the causal effect between the variables A and Y such that the classifier h_{θ} is learned while removing this causal effect. The causal effect between which variables should be considered may be specified or configured by a user and the like in advance or may be configured in the causal graph.

The input unit 101 inputs the training data stored in the training data storage unit 104 and the causal graph stored in the causal graph storage unit 105.

The learning unit 102 learns the classifier h_{θ} using the training data and causal graph input by the input unit 101.

The output unit 103 outputs the parameter θ of the classifier h_{θ} learned by the learning unit 102 to the classification apparatus 20. Destination of the output of the output unit 103 is not limited to the classification apparatus 20 but may be any destination (e.g., an auxiliary storage device of the learning apparatus 10, a storage device accessible to the classification apparatus 20, and the like).

As shown in FIG. 2, the classification apparatus 20 according to the present embodiment includes an input unit 201, a classification unit 202, an output unit 203, and a test data storage unit 204.

The test data storage unit 204 has stored therein test data to be classified with the learned classifier h_{θ}. When the learned classifier h_{θ} is used in recruiting related to an occupation that requires physical strength such as a construction job, the test data will be data representing the features of applicants (i.e., data without assignment of a label representing the result of recruitment).

The input unit 201 inputs the test data stored in the test data storage unit 204.

The classification unit 202 classifies each test data with the learned classifier h_{θ} (i.e., the classifier h_{θ} with the parameter θ output by the learning apparatus 10 being set). In doing so, the classification unit 202 estimates a probability of classification into the class represented by each label by the classifier h_{θ} for each test data. For example, in the case of the specific example mentioned above, the probability of classification into an “accepted” class and the probability of classification into a “rejected” class are estimated for each test data. In actual classification of test data, the test data may be classified into the class represented by the label with the highest probability, for example.

The output unit 203 outputs a classification result from the classification unit 202 (i.e., the probabilities of labels for each test data) to a certain destination (e.g., a display or an auxiliary storage device of the classification apparatus 20).

Although in the present embodiment the learning apparatus 10 and the classification apparatus 20 are described as being different devices, the present invention is not limited thereto; the learning apparatus 10 and the classification apparatus 20 may be integrally configured, for example.

<Learning Process>

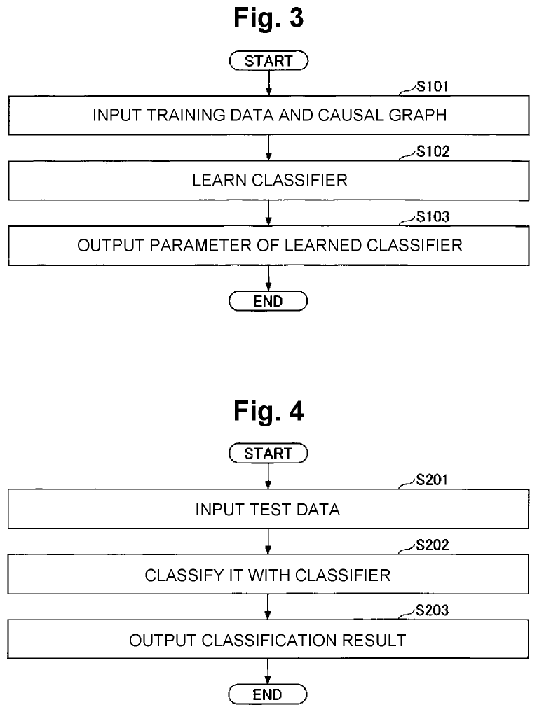

Next, referring to FIG. 3, a process of learning the classifier h_{θ} with the learning apparatus 10 according to the present embodiment is described. FIG. 3 is a flowchart showing an example of a learning process according to the present embodiment.

First, the input unit 101 inputs the training data stored in the training data storage unit 104 and the causal graph stored in the causal graph storage unit 105 (step S101). The causal graph may also be estimated from training data using the method described in Reference Literature 4: Spirtes, Peter and Glymour, Clark. An algorithm for fast recovery of sparse causal graphs. Signal Processing, Social science computer review, 9(1):62-72, 1991, for example.

Then, the learning unit 102 learns the classifier h_{θ} using the training data and causal graph that were input in step S101 (step S102). Specifically, the learning unit 102 learns the classifier h_{θ} such that causal effects are removed by optimizing the objective function shown in Expression (6) above with PG-SMD.

Then, the output unit 103 outputs the parameter θ of the classifier h_{θ} learned in step S102 above to the classification apparatus 20 (step S103).

<Classification Process>

Next, referring to FIG. 4, a process of classifying test data with the classification apparatus 20 according the present embodiment using the classifier h_{θ} which has been learned by the learning apparatus 10 in the present embodiment is described. FIG. 4 is a flowchart showing an example of a classification process in the present embodiment.

First, the input unit 201 inputs the test data stored in the test data storage unit 204 (step S201).

Next, the classification unit 202 classifies the test data input in step S201 above with the learned classifier h_{θ} (step S202). This results in estimation of the probabilities of classification into the classes represented by respective labels for each test data.

Then, the output unit 203 outputs a classification result from step S202 above (i.e., the probabilities of the labels for each test data) to a certain destination (step S203).

<Evaluation>

Results of evaluating the present embodiment using COMPAS dataset, an actual dataset available for public use, are now described.

Table 1 below shows the results of evaluating the classifier h_{θ} learned with the learning apparatus 10 of the present embodiment using the COMPAS dataset (an approach of the present embodiment) and the results of evaluating a classifier that has been learned by the approach described in Non-Patent Literature 1 above (FIO). For evaluation indices, correct classification rate for labels, and the mean value, standard deviation, maximum and minimum of causal effects in test data were used. A causal effect closer to zero means the classification result of the classifier being fairer.

TABLE 1

| | Label correct | Causal effect in test data | | | |
|---|---|---|---|---|---|
| | classification | Mean | Standard | | |
| | rate [%] | value | deviation | Maximum | Minimum |
| Approach of | 65.9 | 8.14 × | 1.13 × | 2.50 × 10⁻³ | −1.26 × 10⁻³ |
| the present | | 10⁻⁴ | 10⁻³ | | |
| embodiment | | | | | |
| FIO | 66.4 | 1.30 × | 1.01 × | 3.11 × 10⁻¹ | −2.41 × 10⁻¹ |
| | | 10⁻⁴ | 10⁻¹ | | |

For the classifier h_{θ} learned with the learning apparatus 10 of the present embodiment, a two-layer neural network was used. The activation function was a sigmoid function and the respective layer were linear layers with 100 and 50 hidden neurons, respectively. Further, an output function was a softmax function and cross-entropy loss was used as the error function l.

As shown in Table 1 above, FIO has a very large variance of causal effects and the maximum and the minimum deviate from zero since FIO constrains only the mean of causal effects. By contrast, the approach of the present embodiment constrains the mean and variance of causal effects, so that, as can be seen, the variance of causal effects is small, the maximum and the minimum are values close to zero, and further the correct classification rate for labels is comparable to that of FIO. It can therefore be seen that the approach of the present embodiment is capable of classification with a correct classification rate comparable to FIO while removing causal effects in each test data.

<Hardware Configuration>

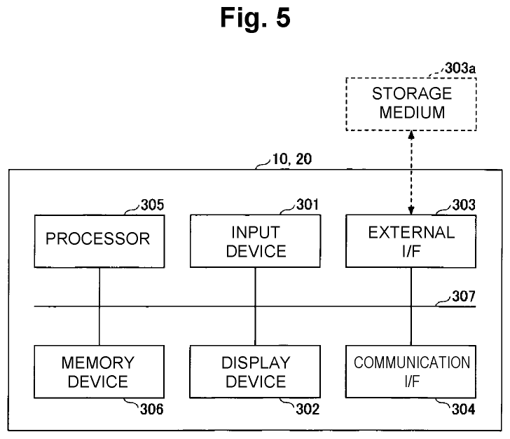

Finally, referring to FIG. 5, hardware configurations of the learning apparatus 10 and the classification apparatus 20 according to the present embodiment are described. FIG. 5 shows an example of the hardware configurations of the learning apparatus 10 and the classification apparatus 20 according to the present embodiment. As the learning apparatus 10 and the classification apparatus 20 can be implemented with similar hardware configurations, the hardware configuration of the learning apparatus 10 will be primarily described below.

As shown in FIG. 5, the learning apparatus 10 according to the present embodiment includes an input device 301, a display device 302, an external I/F 303, a communication I/F 304, a processor 305, and a memory device 306. These hardware devices are each communicatively connected via a bus 307.

The input device 301 can be a keyboard, a mouse, or a touch panel, for example. The display device 302 can be a display, for example. The learning apparatus 10 and the classification apparatus 20 may not include at least either one of the input device 301 and the display device 302.

The external I/F 303 is an interface with external devices. The external devices include a recording medium 303a and the like. The learning apparatus 10 can read or write the recording medium 303a via the external I/F 303 and the like. The recording medium 303a may store one or more programs for implementing the functional components of the learning apparatus 10 (such as the input unit 101, the learning unit 102 and the output unit 103), for example. Likewise, the recording medium 303a may store one or more programs for implementing the functional components of the classification apparatus 20 (such as the input unit 201, the classification unit 202 and the output unit 203), for example.

The recording medium 303a includes a CD (Compact Disc), a DVD (Digital Versatile Disk), an SD memory card (Secure Digital memory card), a USB (Universal Serial Bus) memory card, for example.

The communication I/F 304 is an interface for connecting to a communication network. One or more programs for implementing the functional components of the learning apparatus 10 may be acquired (downloaded) from a certain server device or the like through the communication I/F 304 of the learning apparatus 304. Likewise, one or more programs for implementing the functional components of the classification apparatus 20 may be acquired (downloaded) from a certain server device or the like through the communication I/F 304 of the classification apparatus 20.

The processor 305 can be any of various arithmetic units such as CPU (Central Processing Unit) and GPU (Graphics Processing Unit). The functional components of the learning apparatus 10 are implemented through processing that is caused to be executed by the processor 305 of the learning apparatus 10 by one or more programs stored in the memory device 306 of the learning apparatus 10 and the like. Likewise, the functional components of the classification apparatus 20 are implemented through processing that is caused to be executed by the processor 305 of the classification apparatus 20 by one or more programs stored in the memory device 306 of the classification apparatus 20 and the like.

The memory device 306 can be any of various storage devices such as HDD (Hard Disk Drive), SSD (Solid State Drive), RAM (Random Access Memory), ROM (Read Only Memory), and flash memory. The training data storage unit 104 and the causal graph storage unit 105 can be implemented using the memory device 306 of the learning apparatus 10, for example. Similarly, the test data storage unit 204 can be implemented using the memory device 306 of the classification apparatus 20, for example.

The learning apparatus 10 and the classification apparatus 20 according to the present embodiment can perform the learning process and the classification process mentioned above by having the hardware configuration shown in FIG. 5. Note that the hardware configuration shown in FIG. 5 is an example and the learning apparatus 10 and the classification apparatus 20 may have a different hardware configuration. For example, the learning apparatus 10 and the classification apparatus 20 may have multiple processors 305 or multiple memory devices 306.

The present invention is not limited to the embodiment specifically disclosed above but various modifications or alterations, combination with existing techniques and the like are possible without departing from the scope of claims set forth.

### REFERENCE SIGNS LIST

10 learning apparatus
20 classification apparatus
101 input unit
102 learning unit
103 output unit
104 training data storage unit
105 causal graph storage unit
201 input unit
202 classification unit
203 output unit
204 test data storage unit

1. A learning apparatus comprising a processor configured to execute a method comprising:
inputting training data for learning a classifier and a causal graph representing causal relationships between variables included in the training data; and
learning the classifier by solving a constrained optimization problem in which a mean of causal effects between predetermined variables is within a predetermined range and a variance of the causal effects is equal to or smaller than a predetermined value, using the training data and the causal graph.

2. The learning apparatus according to claim 1, wherein when an error function for quantifying an accuracy of the classifier is represented by a Lipschitz continuous convex function and the classifier is represented by a non-convex and smooth function, and the processor further configured to execute a method comprising:
learning the classifier by optimizing an objective function, the objective function being a weakly convex function that approximates the constrained optimization problem.

3. The learning apparatus according to claim 2, wherein the objective function further includes, as a penalty function, an estimate of an upper confidence bound represented by a sum of a mean of absolute values of the causal effects and a standard deviation of the absolute values of the causal effects, with respect to a mean of the error function associated with an empirical distribution of the training data.

4. A classification apparatus comprising a processor configured to execute a method comprising:
inputting training data for learning a classifier and a causal graph representing causal relationships between variables included in the training data;
learning the classifier by solving a constrained optimization problem in which a mean of causal effects between predetermined variables is within a predetermined range and a variance of the causal effects is equal to or smaller than a predetermined value, using the training data and the causal graph; and
determining a class associated with target data with the learned classifier.

5. A computer-implemented method for learning a class, the method comprising:
inputting training data for learning a classifier and a causal graph representing causal relationships between variables included in the training data; and
learning the classifier by solving a constrained optimization problem in which a mean of causal effects between predetermined variables is within a predetermined range and a variance of the causal effects is equal to or smaller than a predetermined value, using the training data and the causal graph.

6-7. (canceled)

8. The classification apparatus according to claim 4, wherein when an error function for quantifying an accuracy of the classifier is represented by a Lipschitz continuous convex function and the classifier is represented by a non-convex and smooth function, and the processor further configured to execute a method comprising:
learning the classifier by optimizing an objective function, the objective function being a weakly convex function that approximates the constrained optimization problem.

9. The classification apparatus according to claim 8, wherein the objective function further includes, as a penalty function, an estimate of an upper confidence bound represented by a sum of a mean of absolute values of the causal effects and a standard deviation of the absolute values of the causal effects, with respect to a mean of the error function associated with an empirical distribution of the training data.

10. The computer-implemented method according to claim 5, wherein when an error function for quantifying an accuracy of the classifier is represented by a Lipschitz continuous convex function and the classifier is represented by a non-convex and smooth function, and the processor further configured to execute a method comprising:
learning the classifier by optimizing an objective function, the objective function being a weakly convex function that approximates the constrained optimization problem.

11. The computer-implemented method according to claim 10, wherein the objective function further includes, as a penalty function, an estimate of an upper confidence bound represented by a sum of a mean of absolute values of the causal effects and a standard deviation of the absolute values of the causal effects, with respect to a mean of the error function associated with an empirical distribution of the training data.

12. The learning apparatus according to claim 1, wherein the classifier determines a class indicating whether to recruit an individual, and
wherein the variables include a sensitive feature of the individual.

13. The learning apparatus according to claim 1, wherein the classifier determines a class indicating whether to release an individual, wherein the individual corresponds to a prisoner, and wherein the variables include a sensitive feature of the individual.

14. The classification apparatus according to claim 4, wherein the classifier determines a class indicating whether to recruit an individual, and
wherein the variables include a sensitive feature of the individual.

15. The classification apparatus according to claim 4, wherein the classifier determines a class indicating whether to release an individual, wherein the individual corresponds to a prisoner, and wherein the variables include a sensitive feature of the individual.

16. The computer-implemented method according to claim 5, wherein the classifier determines a class indicating whether to recruit an individual, and
wherein the variables include a sensitive feature of the individual.

17. The computer-implemented method according to claim 5, wherein the classifier determines a class indicating whether to release an individual, wherein the individual corresponds to a prisoner, and wherein the variables include a sensitive feature of the individual.
